(19) United States
(12) Patent Application Publication
(10) Pub. No.: US 2025/0377437 A1
(43) Pub. Date: Dec. 11, 2025

(54) METHOD AND DEVICE FOR ULTRA-WIDEBAND (UWB) COMMUNICATION

(71) Applicant: SAMSUNG ELECTRONICS CO., LTD., Suwon-si, Gyeonggi-do (KR)

(72) Inventors: Hyunseob OH, Suwon-si (KR); Jonghoe KOO, Suwon-si (KR); Mingyu LEE, Suwon-si (KR); Kisoo AN, Suwon-si (KR)

(21) Appl. No.: 18/877,220

(22) PCT Filed: Jun. 21, 2022
(86) PCT No.: PCT/KR2022/008783

§ 371 Date: Dec. 19, 2024

(51) Int. Cl. G01S 5/14; H04B 1/7163; H04B 17/318; H04W 64/00

(52) U.S. Cl. CPC G01S 5/14; H04B 1/7163; H04B 17/318; H04W 64/00

(57) ABSTRACT

The present disclosure provides a method for performing DL-TDoA by a UWB device. A method by a UWB device in a wireless communication system according to an embodiment of the present disclosure may comprise the steps of: establishing an active ranging round set; determining whether a number of ranging blocks that have received at least one DT message through the at least one active ranging round during a preconfigured first period is smaller than a predetermined number of ranging blocks; and when the number of ranging blocks that have received the at least one DT message is equal to or greater than the predetermined number of ranging blocks, determining a first candidate active ranging round set on the basis of the at least one DT message.

### TECHNICAL FIELD

The disclosure relates to UWB communication and, more specifically, to a method and a device for providing downlink time difference of arrival (DL-TDoA).

### BACKGROUND ART

The Internet, which is a human centered connectivity network where humans generate and consume information, is now evolving to the Internet of things (IoT) where distributed entities, such as things, exchange and process information. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

With the advance of wireless communication systems as described above, various services can be provided, and accordingly there is a need for ways to effectively provide these services. For example, a ranging technology for measuring the distance between electronic devices by using an ultra-wide band (UWB) may be used. UWB is a technology that uses a very wide frequency band of several GHz or greater in a baseband without using a radio carrier.

### DETAILED DESCRIPTION OF THE INVENTION

### Technical Problem

The disclosure provides a method of dynamically controlling a ranging round for DL-TDoA and a UWB device therefor.

### Technical Solution

A method of an ultra-wideband (UWB) device in a wireless communication system according to various embodiments of the disclosure may include configuring an active ranging round set, the active ranging round set including at least one active ranging round in which the UWB device operates as a DT tag that receives a DT message from a DL-TDoA (DT) anchor, determining whether the number of ranging blocks in which at least one DT message has been received through the at least one active ranging round during a preconfigured first period is smaller than a predetermined number of ranging blocks, and in case that the number of ranging blocks in which the at least one DT message has been received is not smaller than the predetermined number of ranging blocks, determining a first candidate active ranging round set, based on the at least one DT message. A UWB device in a wireless communication system according to various embodiments of the disclosure may include a transceiver, and at least one processor connected to the transceiver, wherein the at least one processor is configured to configure an active ranging round set, the active ranging round set including at least one active ranging round in which the UWB device operates as a DT tag that receives a DT message from a DL-TDoA (DT) anchor, determine whether the number of ranging blocks in which at least one DT message has been received through the at least one active ranging round during a preconfigured first period is smaller than a predetermined number of ranging blocks, and in case that the number of ranging blocks in which the at least one DT message has been received is not smaller than the predetermined number of ranging blocks, determine a first candidate active ranging round set, based on the at least one DT message.

### Advantageous Effects

The method and the device of the disclosure enable reduction of power used for DL-TDoA.

The method and the device of the disclosure enable improvement of the positioning accuracy and the success rate of a terminal.

### BRIEF DESCRIPTION OF DRAWINGS

FIG. 1 illustrates an example architecture of a UWB device.

FIG. 2 illustrates an example configuration of a framework of a UWB device;

FIG. 3 illustrates various examples of a UWB ranging method.

FIG. 4 illustrates an example of a structure of ranging blocks and rounds used for UWB ranging.

FIG. 5 illustrates a method of performing UWB ranging of a DL-TDoA method by a UWB device according to an embodiment of the disclosure.

FIG. 6 illustrates an example of a ranging block structure for a downlink TDoA method according to an embodiment of the disclosure.

FIG. 7 illustrates an example operation and signal flow of a UWB device for DL-TDoA localization according to an embodiment of the disclosure.

FIG. 8 illustrates a ranging block structure divided by ranging rounds and clusters, for DL-TDoA localization, according to an embodiment of the disclosure.

FIG. 9 shows a variation in a UWB RSSI value according to distance according to an embodiment of the disclosure.

FIG. 10 shows a step function value according to g̅ according to an embodiment of the disclosure.

FIG. 11 is a flowchart illustrating a method of dynamically adjusting an active ranging round by a UWB device according to an embodiment of the disclosure.

FIG. 12 shows an example in which a UWB device operates an active ranging round according to an embodiment of the disclosure.

FIG. 13 shows another example in which a UWB device operates an active ranging round according to an embodiment of the disclosure.

FIG. 14 illustrates a structure of a UWB device according to an embodiment of the disclosure.

FIG. 15 illustrates a structure of a UWB device according to an embodiment of the disclosure.

FIG. 16 is a flowchart illustrating a method of a UWB device according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in various embodiments of the disclosure may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet home appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using UWB will be described by way of example, but the embodiments of the disclosure may be applied to other communication systems having similar technical backgrounds or characteristics. Examples of such communication systems may include communication systems Bluetooth or ZigBee. Therefore, based on determinations by those skilled in the art, the embodiments of the disclosure may be applied to other communication systems through some modifications without significantly departing from the scope of the disclosure.

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Generally, wireless sensor network technology is broadly categorized, based on detection distance, into wireless local area network (WLAN) technology and wireless personal area network (WPAN) technology. WLAN refers to technology based on IEEE 802.11, and enables connection to a backbone network within a radius of approximately 100 m. WPAN is technology based on IEEE 802.15, and includes Bluetooth, ZigBee, and ultra-wideband (UWB) communication. A wireless network where such wireless network technologies are implemented may include multiple electronic devices.

UWB may refer to a short-range and high-speed wireless communication technology utilizing a broad frequency band of several GHz or higher, low spectral density, and a narrow pulse width (1-4 nsec) in a baseband state. UWB may also denote a band to which UWB communication is applied. UWB enables secure and accurate ranging between devices. Accordingly, UWB also enables relative position estimation based on the distance between two devices or precise location estimation of a device based on distances from fixed devices (the positions of which are known).

Specific terms used in the following description are provided to facilitate understanding of the disclosure, and use of these specific terms may be modified in other forms without departing from the technical spirit of the disclosure.

An “application dedicated file (ADF)” may, for instance, be a data structure within an application data structure capable of hosting applications or application-specific data.

“Application protocol data unit (APDU)” may refer to a command and a response used when communicating with an application data structure in a UWB device.

“Application-specific data” may, for example, be a file structure having root and application levels, which includes UWB controlee information and UWB session data required for a UWB session.

A “controller” may be a ranging device that defines and controls ranging control messages (RCMs) (or control messages). The controller may define and control ranging features by sending a control message.

A “Controlee” may be a ranging device that uses a ranging parameter within an RCM (or control message) received from a controller. The controlee may utilize ranging features as configured by a controller through a control message.

“Dynamic scrambled timestamp sequence (STS) mode” unlike “static STS” may be an operational mode where an STS does not repeat during a ranging session. In this mode, the STS is managed by a ranging device, and a ranging session key that generates the STS may be managed by a secure component.

An “applet” may be, for example, an applet executed on a secure component, which includes service data and UWB parameters. In the disclosure, the applet may be a FiRa applet.

A “ranging device” may refer to a device capable of performing UWB ranging. In the disclosure, the ranging device may be an enhanced ranging device (ERDEV) defined in IEEE 802.15.4z or a FiRa device. The ranging device may be called a UWB device.

A “UWB-enabled application” may be an application for a UWB service. For example, the UWB-enabled application may be an application using a framework API for configuring an OOB connector, a secure service, and/or a UWB service, for a UWB session. In the disclosure, the “UWB-enabled application” may be abbreviated as an application or UWB application. The UWB-enabled application may be a FiRa-enabled application.

A “framework” may be a component that provides access to a profile, individual UWB configurations, and/or notifications. The framework may be, for example, a collection of logical software components, including a profile manager, an OOB connector, a secure service, and/or a UWB service. In the disclosure, the framework may be a FiRa framework.

An “OOB connector” may be a software component for configuring an out-of-band (OOB) connection (e.g., BLE connection) between ranging devices. In the disclosure, the OOB connector may be a FiRa OOB connector.

A “profile” may refer to a predefined set of UWB and OOB configuration parameters. In the disclosure, the profile may be a FiRa profile.

A “profile manager” may be a software component that implements an available profile on a ranging device. In the disclosure, the profile manager may be a FiRa profile manager.

A “service” may be an implementation of a use case of providing a service to an end user.

A “smart ranging device” may be a ranging device capable of implementing an optional framework API. In the disclosure, the smart ranging device may be a FiRa smart device.

A “global dedicated file (GDF)” may be a root level of application-specific data including data necessary to configure a USB session.

A “framework API” may be an API used by a UWB-enabled application to communicate with a framework.

An “initiator” may be a ranging device that initiates a ranging exchange. The initiator may begin a ranging exchange by transmitting a first RFRAME (ranging exchange message).

An “object identifier (OID)” may be an identifier of an ADF within an application data structure.

“Out-Of-Band (OOB)” may refer to data communication that does not use UWB as an underlying wireless technology.

A “ranging data set (RDS)” may refer to data (e.g., a UWB session key, a session ID, etc.) required for configuring a UWB session requiring protection of confidentiality, authenticity, and integrity.

A “responder” may be a ranging device that responds to an initiator during a ranging exchange. The responder may reply to a ranging exchange message received from an initiator.

An “STS” may refer to a ciphered sequence used to enhance the integrity and accuracy of ranging measurement timestamps. The STS may be generated from a ranging session key.

A “secure channel” may be a data channel that prevents overhearing and tampering.

A “secure component” may be, for example, an entity (e.g., SE or TEE) having a defined security level, which interfaces with a UWBS to provide an RDS to the UWBS when a dynamic STS is used.

A “secure element (SE)” may be a tamper-resistant secure hardware component usable as a secure component in a ranging device.

“Secure Ranging” may refer to ranging based on an STS generated through a strong cryptographic operation.

A “secure service” may be a software component for interfacing with a secure component, such as a secure element or trusted execution environment (TEE).

A “service applet” may be an applet on a secure component, which handles a service-specific transaction.

“Service Data” may refer to data defined by a service provider and required to be transferred between two ranging devices to implement a service.

A “service provider” may be an entity that defines and provides hardware and software required for providing a specific service to an end user.

“Static STS mode” may refer to an operational mode where an STS is repeated during a session and does not need to be managed by a secure component.

A “secure UWB service (SUS) applet” may be an applet on an SE that communicates with an applet to search for data required for enabling a secure UWB session with another ranging device. In addition, the SUS applet may transfer corresponding data (information) to a UWBS.

A “UWB service” may be a software component that provides access to a UWBS.

A “UWB session” may refer to a period from when a controller and a controlee initiate communication over UWB to when they stop communication. The UWB session may include ranging transfer, data transfer, or both ranging and data transfer.

A “UWB session ID” may be an ID (e.g., a 32-bit integer) that identifies a UWB session shared between a controller and a controlee.

A “UWB session key” may be a key used to protect a UWB session. The UWB session key may be used to generate an STS. In the disclosure, the UWB session key may be referred to as a UWB ranging session Key (URSK) and may be abbreviated as a session key.

A “UWB subsystem (UWBS)” may be a hardware component that implements UWB PHY and MAC layers (specifications). The UWBS may have an interface for a framework and an interface for a secure component for searching for an RDS.

“DL-TDoA” may be referred to as downlink time difference of arrival (DL-TDoA) and may be a positioning method in which one or multiple tag devices (DT-Tags) estimate its location, based on a DL-TDoA (DT) message (DTM) received from at least one anchor device (DT-anchor). In DL-TDoA, an anchor device transmits or broadcasts a DTM, and a tag device passively receives the DTM, whereby exposure of the tag device's location may be prevented.

An anchor device may precisely measure its own DTM transmission time and a reception time of a received DTM. The anchor device may include a transmission time in a transmitted or broadcast DTM. A tag device may measure the reception times of all received DTMs and use the obtained coordinates of anchor devices and reception timestamps to estimate the tag device's location. DL-TDoA may be classified as a type of one-way ranging, similar to uplink TDoA. In the disclosure, DL-TDoA may be referred to as DL-TDoA localization.

An “anchor device” may be referred to as a UWB anchor, a UWB anchor device, a DL-TDoA anchor, or a DT-anchor and may be a UWB device placed at a specific location to provide a positioning service. The anchor device may be a device transmitting a DTM which may be used by a tag device to calculate a position, based on TDoA localization (DL-TDoA localization). For example, the anchor device may be a UWB device installed by a service provider on an indoor wall, a ceiling, and a structure to provide an indoor positioning service. The anchor device may participate in a ranging round as an initiator anchor or a responder anchor classified depending on the sequence and role of message transmission.

An “initiator anchor” may be called an initiator UWB anchor, an initiator anchor device, or an initiator DT-anchor, and may inform of the start of a TDoA ranging round (DL-TDoA ranging round). The initiator anchor may initiate a DL-TDoA ranging round by transmitting an initiation message and schedule the transmission time of a responder anchor. For example, the initiator anchor may schedule ranging slots in which responder anchors operating in the same ranging round do response messages (response DTMs). In the disclosure, the initiation message may be referred to as an initiator DTM, a poll message, or a poll DTM.

An initiator anchor may additionally transfer a final message (final DTM) after receiving responses from responder anchors. The initiator anchor may additionally transmit a final message (final DTM) after all responder anchors in the same cluster have transmitted response messages (response DTMs) in a DL-TDoA ranging round. In the disclosure, the final message may be referred to as a final DTM.

A DL-TDoA network may have at least one reference initiator anchor. The reference initiator anchor is an initiator anchor, and may serve as a global time reference for inter-cluster synchronization and configure a common ranging block structure for the operation of the DL-TDoA network. In the disclosure, the reference initiator anchor may be referred to as a master anchor or a global anchor.

A “responder anchor” may be referred to as a responder UWB anchor, a responder UWB anchor device, or a responder anchor device. The responder anchor may be a UWB anchor that responds to an initiation message from an initiator anchor. The responder anchor may reply to the initiator anchor by using a response message. In the disclosure, the response message may be referred to as a responder DTM.

A “tag device” may be referred to as a UWB tag, a user device, a UWB tag device, a DL-TDoA Tag, or a DT-Tag. The tag device may estimate its location (e.g., geographical coordinates) by using a TDoA measurement, based on a DTM received from an anchor device. The tag device may be aware of the location of the anchor device.

The tag device may receive a message transmitted by the anchor device and measure the reception time of the message. The tag device may obtain the geographical coordinates of the anchor device through an in-band or out-of-band method. The tag device may skip a ranging block if a location update rate is lower than that supported by a network.

A “cluster” may refer to a set of anchor devices covering a specific area. The cluster may refer to a set of anchor devices exchanging a DTM to provide a location service to at least one tag device. The cluster may be configured by an initiator anchor and at least one responder anchor.

One anchor device may operate in one or more clusters. In this case, an anchor device acting as an initiator anchor in some clusters may operate as a responder anchor in other clusters. The area of a cluster may correspond to a space made by anchor devices included in the cluster. To support a positioning service over a wide area, multiple clusters may be configured to provide the positioning service to a user device. In the disclosure, a cluster may also be referred to as a cell. In the disclosure, an operation of a cluster may be understood as an operation of an anchor device(s) belonging to the cluster.

In addition, in describing the disclosure, a detailed description of relevant known functions or configurations will be omitted when it may make the subject matter of the disclosure rather unclear.

Hereinafter, embodiments of the disclosure will be described with reference to the accompanying drawings.

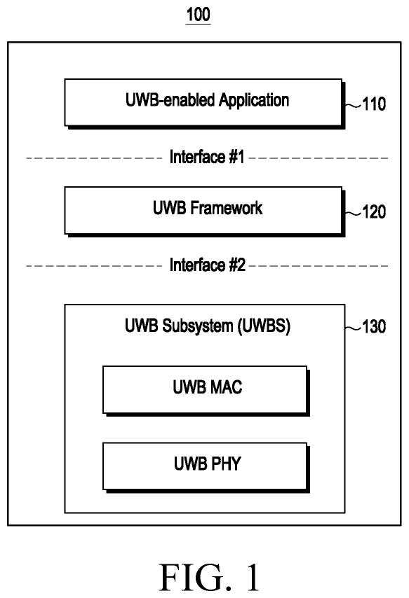

FIG. 1 illustrates an example architecture of a UWB device.

In the disclosure, a UWB device 100 may be an electronic device supporting UWB communication. The UWB device 100 may, for example, be a ranging device supporting UWB ranging. In an embodiment, the ranging device may be an enhanced ranging device (ERDEV) defined in IEEE 802.15.4z or a FiRa device.

In an embodiment of FIG. 1, the UWB device 100 may interact with another UWB device through a UWB session.

In addition, the UWB device 100 may implement a first interface (interface #1) that is an interface between a UWB-enabled application 110 and a UWB framework 120, and the first interface may enable the UWB-enabled application 110 on the UWB device 100 to use UWB performances of the UWB device 100 in a predetermined way. In an embodiment, the first interface may be a framework API or a proprietary interface, but is not limited thereto.

In addition, the UWB device 100 may implement a second interface (interface #2) that is an interface between the UWB framework 110 and a UWB subsystem (UWBS) 130. In an embodiment, the second interface may be a UWB command interface (UCI) or a proprietary interface, but is not limited thereto.

Referring to FIG. 1, the UWB device 100 may include the UWB-enabled application 110, a framework (UWB Framework) 120, and/or the UWBS 130 including a UWB MAC layer and a UWB physical layer. According to an embodiment, some entities may not be included in the UWB device or additional entities (e.g., security layers) may be further included therein.

The UWB-enabled application 110 may trigger configuration of a UWB session by the UWBS 130 by using the first interface. In addition, the UWB-enabled application 110 may use one of pre-defined profiles. The UWB-enabled application 110 may handle a relevant event, such as service discovery, ranging notifications, and/or error conditions, by using the first interface.

The framework 120 may provide access to a profile, individual UWB configurations, and/or notifications. In addition, the framework 120 may support at least one of a function for performing UWB ranging and transaction, a function of providing an interface for the UWBS 130 and the application, or a function of estimating the position of the device 100. The framework 120 may be a set of software components. As described above, the UWB-enabled application 110 may interface with the framework 120 through the first interface, and the framework 120 may interface with the UWBS 130 through the second interface.

In the disclosure, the UWB-enabled application 110 and/or the framework 120 may be implemented by an application processor (AP) (or processor). Therefore, in the disclosure, an operation of the UWB-enabled application 110 and/or the framework 120 may be understood as being performed by an AP (or processor). In the disclosure, the framework may be referred to as an AP or processor.

The UWBS 130 may be a hardware component including a UWB MAC layer and a UWB physical layer. The UWBS 130 may perform UWB session management and communicate with a UWBS of another UWB device. The UWBS 130 may interface with the framework 120 through the second interface, and obtain secure data from a secure component. In an embodiment, the framework (or application processor) 120 may transmit a command to the UWBS 130 through a UCI, and the UWBS 130 may transfer a response for the command to the framework 120. The UWBS 130 may also transfer a notification to the framework 120 through the UCI.

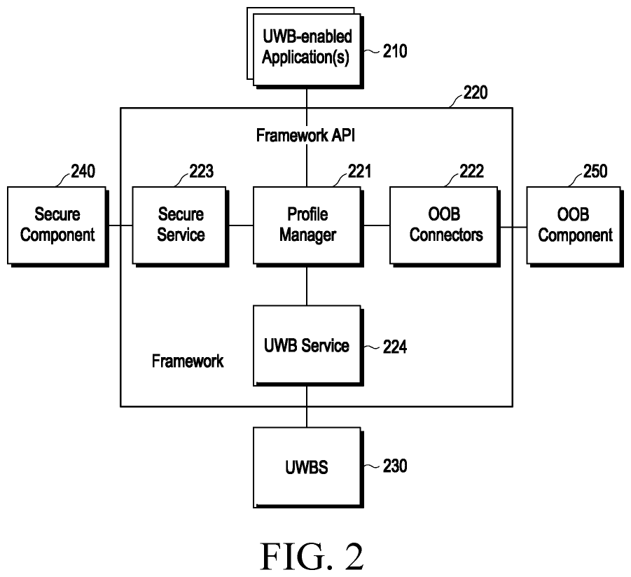

FIG. 2 illustrates an example configuration of a framework of a UWB device.

The UWB device in FIG. 2 may be an example of the UWB device in FIG. 2.

Referring to FIG. 2, a framework 220 may include, for example, a software component, such as a profile manager 221, an OOB connector(s) 222, a secure service 223, and/or a UWB service 224.

The profile manager 221 may function to manage a profile available on the UWB device. The profile may be a set of parameters required for configuring communication between UWB devices. For example, the profile may include a parameter indicating which OOB secure channel is used, a UWB/OOB configuration parameter, a parameter indicating whether use of a parameter secure component is mandatory, and/or a parameter related to a file structure of an ADF. A UWB-enabled application 210 may communicate with the profile manager 221 through a first interface (e.g., framework API).

The OOB connector 222 may function to configure an OOB connection with another device. The OOB connector 222 may handle an OOB stage including a discovery stage and/or connection stage. An OOB component (e.g., BLE component) 250 may connect to the OOB connector 222.

The secure service 223 may function to interface with a secure component 240 such as an SE or TEE.

The UWB service 224 may function to manage a UWBS 230. The UWB service 224 may implement a second interface to provide access from the profile manager 221 to the UWBS 230.

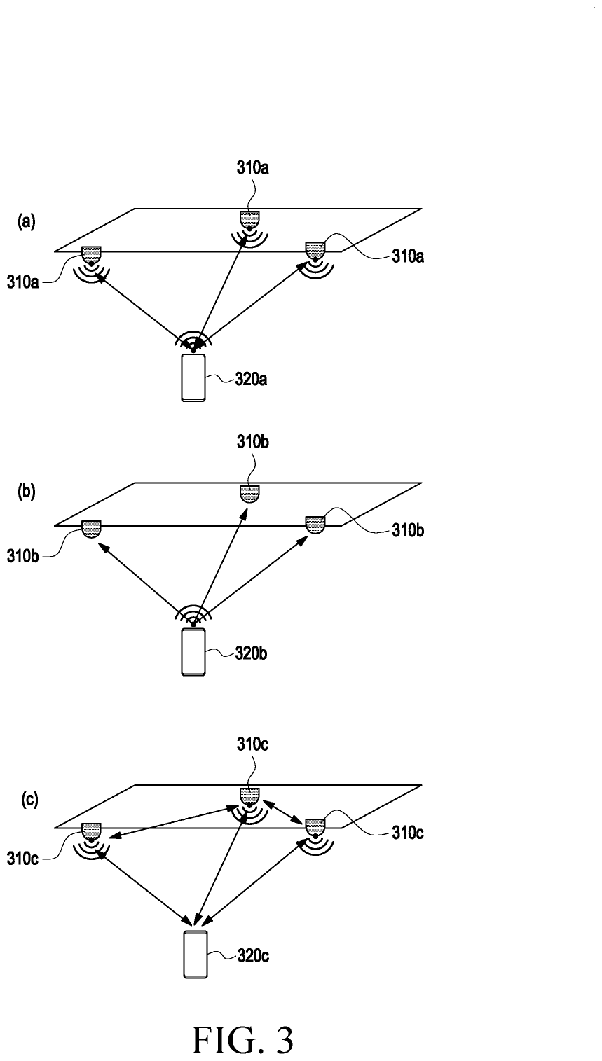

FIG. 3 show various examples of a UWB ranging method.

FIG. 3A illustrates an example of a two-way ranging (TWR) method, FIG. 3B illustrates an example of an uplink time difference of arrival (TDoA) method (one-way ranging (OWR)), and FIG. 3C illustrates an example of a downlink TDoA method (OWR).

In the disclosure, the TWR method corresponds to a method in which UWB devices exchanges ranging messages with each other to calculate a time of flight (ToF) and determines the location of a UWB device, based on the messages. The uplink TDoA method is a method in which UWB anchors receive a ranging message transmitted by a UWB device (tag), calculate a time difference (TDoA), and determine the location of the UWB device, based on the time difference, and corresponds to one of OWR methods. The downlink TDoA method is a method in which a UWB device (tag) receives ranging messages transmitted by UWB anchors, calculates a time difference (TDoA), and determines the location of the UWB device, based on the time difference, and corresponds to one of OWR methods.

Referring to FIG. 3A, a UWB device 320a of a user may perform ranging through a ranging exchange, with at least one UWB anchor 310a, using multiple ranging messages. The TWR method of FIG. 3A may follow a method defined in IEEE 802.15.4/4z. TWR, as illustrated in FIG. 3A, does not need synchronization or networking between UWB anchors and enables easy installation. However, the number of users (user devices) is limited.

Referring to FIG. 3B, a UWB device 320b of a user may transmit (broadcast) ranging messages to at least one UWB anchor 310b, and the at least one UWB anchor 310b may identify the location of the UWB device 320b by using a time difference (TDoA) at which the ranging messages are received. Uplink TDoA (OWR), as illustrated in FIG. 3B, has the advantage of reducing the power consumption in a user device, but has disadvantages in that synchronization or networking between UWB anchors is required and thus installation is difficult, a system operator knows the location of all users, which may lead to privacy issues, and the number of users (user devices) is still limited.

Referring to FIG. 3C, a UWB device 320c of a user may receive (sniff) ranging messages transmitted/received by at least one UWB anchor 310c with each other, and identify the location of the UWB device. Downlink TDoA (OWR), as illustrated in FIG. 3C, is advantageous in that the number of user devices is not limited (scalability), there are no privacy issues as in uplink TDoA (privacy), synchronization or networking between UWB anchors is not required to enable easy installation (easy to install), a user device is able to calculate the location thereof by itself, and advanced location calculation is possible using additional data such as sensor data of a user device. However, downlink TDoA (OWR) of FIG. 3C has the disadvantage of increasing the power consumption in a user device due to a longer wake-up duration and many calculations, compared to TWR of FIG. 3A and uplink TDoA (OWR) of FIG. 3B.

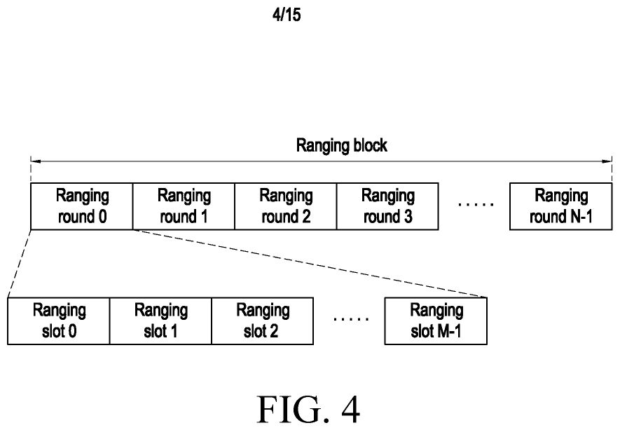

FIG. 4 illustrates an example of a structure of ranging blocks and rounds used for UWB ranging.

In the disclosure, a ranging block denotes a time period for ranging. A ranging round may be a sufficient period (period of sufficient duration) for completing the one entire ranging-measurement cycle) involving a set of UWB devices participating in a ranging exchange. A ranging slot may be a sufficient period for transmission of at least one ranging frame (RFFRAME) (e.g., ranging initiation/response/final message, etc.).

As illustrated in FIG. 4, one ranging block may include at least one ranging round, and each ranging round may include at least one ranging slot.

If a ranging mode is a block-based mode, the mean time of consecutive ranging rounds may be a constant. Alternatively, if a ranging mode is an interval-based mode, the times of consecutive ranging rounds may be dynamically changed. That is, the interval-based mode may adopt a time structure having adaptive spacing.

The number of slots included in a ranging round and the duration thereof may be changed between ranging rounds. This difference may be configured through a control message from a controller.

In the disclosure, a ranging block, a ranging round, and a ranging slot may be abbreviated as a block, a round, and a slot, respectively.

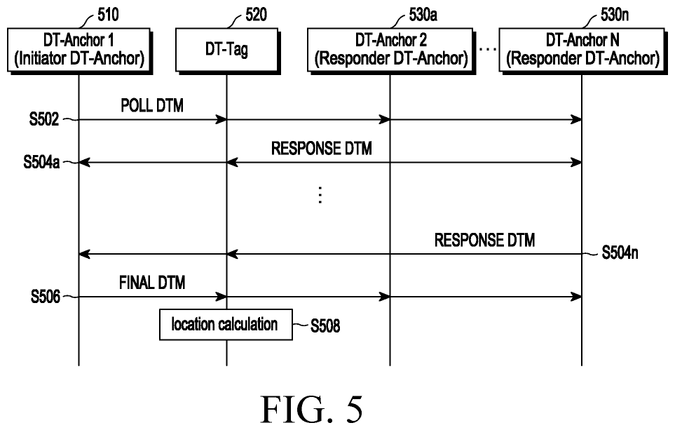

FIG. 5 illustrates a method of performing UWB ranging of a DL-TDoA method by a UWB device according to an embodiment of the disclosure.

An embodiment of FIG. 5 assumes that a UWB device (e.g., mobile device) 520 of a user operates as a tag (tag device). In addition, it is assumed that one initiator anchor 510 and n responder anchors 530a, . . . , and 530n operate UWB anchors (anchor devices). However, embodiments are not limited thereto, and the number of initiator anchors and responder anchors may be variously configured according to embodiments.

First, in operation S502, the initiator anchor 510 may transmit or broadcast a poll DTM received by a responder anchor in a cluster to initiate a DL-TDoA round. The poll DTM may include scheduling information on each responder anchor to transmit a response DTM in an allocated ranging slot.

In an embodiment, each of the responder anchors 530a, . . . , and 530n may refer to scheduling information in an initiator DTM, thereby knowing whether to transmit a TDoA response message (response DTM), and a slot used to transmit a response DTM.

In operations S504a . . . , and S504n, each of the responder anchors 530a, . . . , and 530n having received the poll DTM may respond to the initial anchor 510 by using a response DTM in a ranging slot allocated by the poll DTM.

In operation S506, the initiator anchor 510 having received the response DTM may additionally transmit a final DTM to the responder anchors 530a, . . . , and 530n.

In operation S508, the tag device 520 may receive the exchanged poll DTM, response DTMs, and final DTM, and calculate TDoA values through information and reception timestamps included in the messages. The tag device 520 may obtain (or estimate) the location thereof by using the calculated TDoA values.

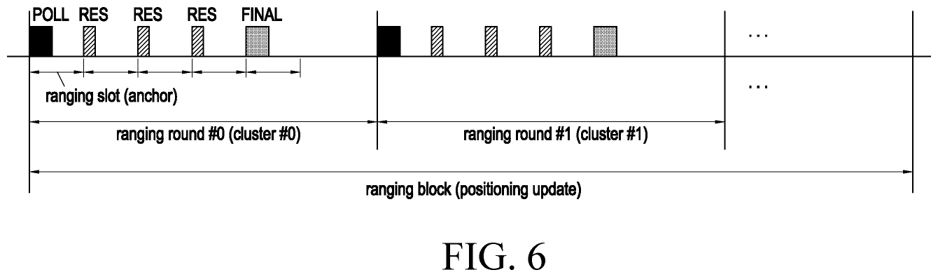

FIG. 6 illustrates an example of a ranging block structure for a downlink TDoA method according to an embodiment of the disclosure.

The downlink TDoA method of FIG. 6 may be, for example, the downlink TDoA method of FIG. 5.

Referring to FIG. 6, a ranging block may include multiple ranging rounds.

As an embodiment, a ranging block may include multiple ranging rounds allocated for multiple clusters, respectively. For example, if n clusters are arranged, a ranging block may include a first ranging round allocated for a first cluster, a second ranging round allocated for a second cluster, . . . , and a n-th ranging round allocated for an n-th cluster. Although not illustrated in FIG. 6, in some embodiments, multiple ranging rounds may be allocated to one cluster, and one ranging round is allocatable to multiple clusters.

In an embodiment, a ranging round may include multiple ranging slots. A ranging round may include multiple ranging slots allocated for ranging messages transmitted by respective anchor devices belonging to a cluster associated with the ranging round. For example, if a first cluster includes one initiator anchor and three responder anchors, a ranging round for the first cluster may include a first ranging slot (e.g., ranging slot 0) allocated for transmission/reception of a poll message of the initiator anchor included in the first cluster, a second ranging slot allocated for transmission/reception of a response message of a first responder anchor, a third ranging slot allocated for transmission/reception of a response message of a second responder anchor, a fourth ranging slot allocated for transmission/reception of a response message of a third responder anchor, and a fifth ranging slot allocated for transmission/reception of a final message of the initiator anchor.

Through this way, ranging slots may be allocated to a ranging round for each cluster.

Through a ranging block structure as in the embodiment of FIG. 6, each cluster may transmit/receive ranging messages thereof (e.g., poll/response/final message (DTM)) through a ranging round thereof one time in a single ranging block, and a user device (tag device) may receive the ranging messages to calculate the location thereof. This operation may be repeated for each ranging block. Accordingly, the location of the user device may be updated according to a period of a ranging block.

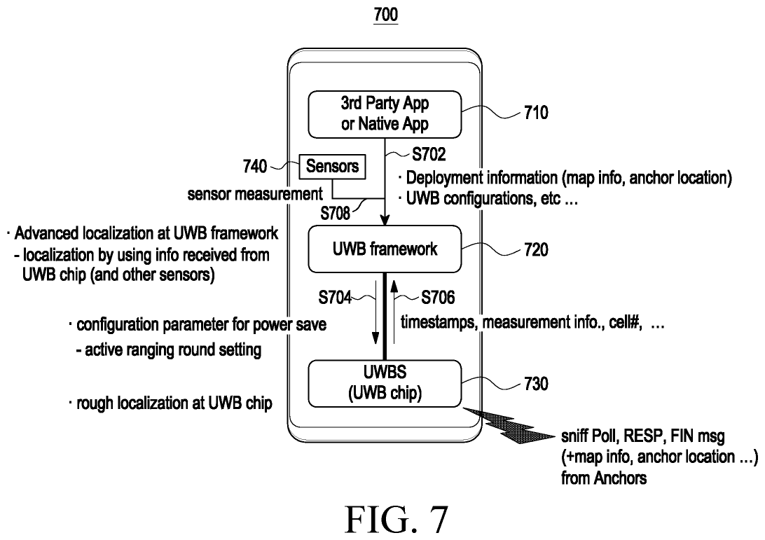

FIG. 7 illustrates an example operation and signal flow of a UWB device for DL-TDoA localization according to an embodiment of the disclosure.

A UWB device 700 in an embodiment of FIG. 7 may be, for example, an embodiment of the UWB device in FIG. 1. The UWB device 700 in the embodiment of FIG. 7 may function as a tag device for DL-TDoA localization.

Referring to FIG. 7, the UWB device 700 may include at least one application 710, a UWB framework 720, a UWB subsystem (UWBS) 730, and/or at least one sensor 740. In the disclosure, the UWBS 730 may also be called as a UWB chip.

Hereinafter, an operation and a signal flow of each element are described.

### (1) At Least One Application (Hereinafter, Application) 710

The application 710 may include a 3rd party application (APP) and/or a native application (APP). As an embodiment, the native application (APP) may be a UWB-enabled application.

The application 710 may transfer a first signal S702 to the UWB framework 720. In an embodiment, the first signal S702 may include deployment information and/or UWB configuration information. The deployment information may include map information of a corresponding area and/or location information of an anchor device disposed in the corresponding area. As an embodiment, the location information of the anchor device may include information on a relative location for a particular location in the corresponding area and/or, for example, information on an absolute location configured by a latitude and a longitude. The UWB configuration information may include at least one of a UWB channel number, a preamble CI, an STS index value for generating an STS, a service identifier, or key information for data encryption/decryption, which allow the UWBS 730 to perform DL-TDoA localization.

The application 710 may provide a UWB service. For example, the application 710 may provide a UWB service based on DL-TDoA localization.

### (2) UWB Framework 720

The UWB framework 720 may receive the first signal S702 from the application 710, a third signal S706 from the UWBS 730, and/or a fourth signal S708 from the at least one sensor 740. As described above, the first signal S702 may include deployment information and/or UWB configuration information. Although not illustrated in FIG. 7, the UWB device 700 may also obtain additional information through an external BLE device through a BLE OOB connector (component) included in the UWB framework 720. As an embodiment, the BLE OOB connector may exchange information through BLE pairing with the external BLE device, or may receive a BLE advertisement message to obtain information. The information may be deployment information and/or UWB configuration information included in the first signal S702.

In an embodiment, the third signal S706 may include information on the transmission/reception timestamp(s) of ranging messages for DL-TDoA localization, measurement information (ranging measurement information), cluster information (e.g., cluster (cell) number (#) information), and/or UWB anchor information (e.g., the identifier of an anchor device, a MAC address of the anchor device, and location information of the anchor device), as well as simple calculation results. As an embodiment, the measurement information may include information on a response time of a response message and/or include information on a response time of a final message.

In an embodiment, the fourth signal S708 may include sensor measurement information (sensing data). The sensor measurement information may include information on the acceleration of a terminal along the x, y, and z axes measured by an acceleration sensor and/or information on the angular velocity of the terminal along the x, y, and z axes measured by an inertial sensor. The information obtained through the fourth signal S708 may be used for the UWB framework 720 or the application 710 to estimate the location and movement of the terminal.

The UWB framework 720 may perform a first localization operation, based on information included in at least one received signal. For example, the UWB framework 720 may perform localization (DL-TDoA localization), based on information included in the third signal S706 received from the USBS 730. The UWB framework 720 may perform DL-TDoA localization by further using information included in the fourth signal S708 received from the at least one sensor 740. In this case, compared to using only information obtained from the UWBS 730, additionally obtained sensing data is used to predict the location (coordinates) and movement of the UWB device 700, so that more advanced or more correct localization may be performed. In the disclosure, localization performed by the UWB framework 720 may be called advanced localization or first localization.

The UWB framework 720 may transfer a second signal S704 to the UWBS 730. In an embodiment, the second signal S704 may include configuration information (parameter) for power saving. For example, the second signal S704 may include information on an active ranging round configuration as a configuration parameter for power saving.

### (3) UWBS 730

The UWBS 730 may receive at least one ranging message for DL-TDoA localization transmitted by at least one anchor (UWB anchor). For example, the UWBS 730 may perform an operation of receiving (or sniffing) a poll message, a response message, and a final message from an initiator anchor and at least one responder anchor. The messages may include map information and information on anchor location.

The UWBS 730 may perform a second localization operation, based on information included in at least one received ranging message. In the second localization operation performed by the UWBS 730, available information is limited compared to the UWB framework 720 that is an upper layer (e.g., use of sensing data is difficult), and thus rougher localization compared to the UWB framework 720 is possible. In the disclosure, localization performed by the UWBS 730 may be called rough localization or second localization.

### (4) At Least One Sensor 740

The at least one sensor 740 may sense a surrounding environment to obtain sensing data. As an embodiment, the at least one sensor 740 may include, for example, an acceleration sensor and/or an inertial sensor.

The at least one sensor 740 may transfer the fourth signal S708 including sensing data to the UWB framework 720. The transferred sensing data may be used for DL-TDoA localization in the UWB framework 720.

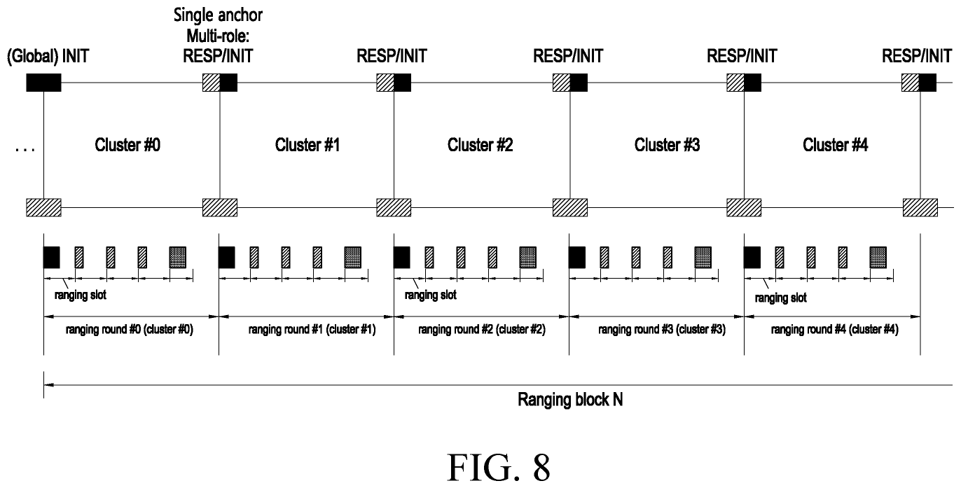

FIG. 8 illustrates a ranging block structure divided by ranging rounds and clusters, for DL-TDoA localization, according to an embodiment of the disclosure.

The ranging block structure in FIG. 8 may be an example of the ranging block structure in FIG. 6.

Referring to FIG. 8, multiple clusters (e.g., clusters #0 to #4) may be arranged, each cluster may include one initiator anchor and multiple responder anchors (e.g., three responder anchors), and one of initiator anchors may be configured as a reference initiator anchor.

One anchor device may be included in multiple clusters. For example, a responder anchor of cluster #0 may function as an initiator anchor of cluster #1.

Referring to FIG. 8, a ranging block may include multiple ranging rounds allocated for respective clusters. For example, as illustrated in the drawing, ranging block #n may include a first ranging round (ranging round #0) allocated for cluster #0, a second ranging round (ranging round #1) allocated for cluster #1, a third ranging round allocated for cluster #2, . . . , a m-th ranging round allocated for cluster #m−1, and a (m+1) th ranging round allocated for cluster #m. In addition, ranging block #n+1 subsequent to ranging block #n may also include a first ranging round (ranging round #0) allocated for cluster #0, a second ranging round (ranging round #1) allocated for cluster #1, a third ranging round allocated for cluster #2, . . . , a m-th ranging round allocated for cluster #m−1, and a (m+1) th ranging round allocated for cluster #m.

As an embodiment, a ranging round may include multiple ranging slots allocated for ranging messages transmitted by respective anchor devices belonging to a cluster associated with the ranging round. For example, as illustrated in the drawing, the second ranging round for cluster #1 may include a first ranging slot for transmission of a poll message of an initiator anchor of cluster #1, a second ranging slot for transmission of a first response message of a first responder anchor of cluster #1, a third ranging slot for transmission of a second response message of a second responder anchor of cluster #1, a fourth ranging slot for transmission of a third response message from a third responder anchor of cluster #1, and a fifth ranging slot for transmission of a final message of the initiator anchor of cluster #1. In addition, the first ranging round of the remaining ranging rounds of the ranging block may also include a first ranging slot for transmission of a poll message of an initiator anchor of the cluster, a second ranging slot for transmission of a first response message of a first responder anchor of the cluster, a third ranging slot for transmission of a second response message of a second responder anchor of the cluster, a fourth ranging slot for transmission of a third response message from a third responder anchor of the cluster, and a fifth ranging slot for transmission of a final message of the initiator anchor of the cluster.

A ranging device functioning as a controller may transmit a DL-TDoA control message for DL-TDoA, and the DL-TDoA message may include ranging time structure information (e.g., ranging block or round duration). Even if a tag device (or terminal) receives the control message, when the tag device has difficulty in specifying, at a current place, an active ranging round in which a DL-TDoA message (e.g., poll message, resp. message, or final message) is transmitted, the tag device needs to listen to all ranging blocks. However, if an active ranging round is specified, the tag device (or terminal) may listen to only the active ranging round among all ranging rounds in the ranging block.

In the disclosure, various embodiments for configuring such an active ranging round are described. For example, the disclosure provides embodiments of configuring an active ranging round for a tag device (or terminal) having mobility.

In a case of active ranging round configuration, there may be a tradeoff between a positioning frequency and energy consumption. For example, in order to avoid non-reception of a DL-TDoA message, all ranging rounds may be designated as active ranging rounds. In this case, a positioning frequency at a terminal side increases and thus energy consumption may be rapidly increased. On the contrary, in a case where a terminal selectively designates an active ranging round to reduce energy consumption, when an incorrect ranging round is designated, the frequency of positioning failure may be increased.

Therefore, hereinafter, a method of configuring a proper active ranging round set, based on a message received from a current cluster by considering the mobility of a terminal will be described. As an embodiment, a terminal (e.g., a terminal mounted in a vehicle) having high mobility may use active ranging round information allocated to a neighboring cluster together, so as to configure a valid active ranging round set. Another embodiment may propose a method of reconfiguration to configure a valid active ranging round set when an invalid active ranging round is configured for a terminal.

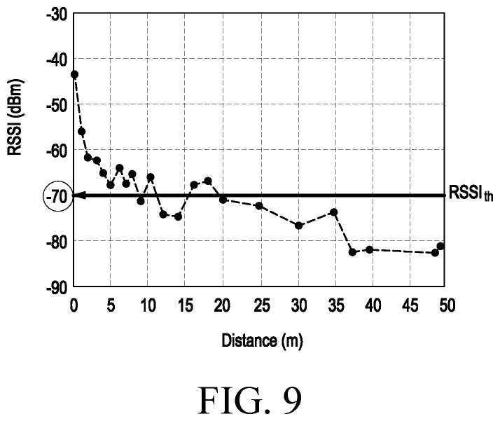

With reference to FIG. 9 to FIG. 13, a method of dynamically adjusting an active ranging round set, based on information (e.g., information on an operated round, information on the number of received messages, and a value obtained by calculating TDoA) obtained by receiving a DL-TDoA message will be described. In this case, an initiator anchor that transmits a poll message may transmit operation information (e.g., operated ranging round) of both a cluster where the initiator anchor belongs and a neighboring cluster. In addition, a terminal (tag device) may estimate a candidate active ranging round set and a marginal ranging round set, based on information obtained from DL-TDoA messages received during a predetermined time (e.g., multiple ranging blocks) for an active ranging round currently being operated.

First, terms used to describe the method proposed in FIG. 9 to FIG. 13 are described.

M may denote a maximum number of configurable ranging rounds. That is, M may indicate the number of ranging rounds per ranging block. For example, if 20 ranging rounds exist in a single ranging block, M may be equal to 20 (M=20).

R_{c} may denote a set of configurable ranging rounds. Same may be represented as R_{c}:={m|0≤m<M−1}. For example, if 20 ranging rounds exist in a single ranging block, the number of elements in the set R_{c} may be equal to 20.

ARᵢₙᵢₜ may denote an initial active ranging round set. As an initial value, ARᵢₙᵢₜ may be equal to R_{c}.

R̅S̅S̅I̅(m) may indicate a mean received signal strength indicator (RSSI) value of a m-th round.

RSSI may denote a set of mean RSSI values. Same may be represented as

$$RSSI := \{ \overline{RSSI} ( 0 ) , \overline{RSSI} ( 1 ) , … , \overline{RSSI} ( M - 1 ) \} .$$

RSSIₜₕ denotes a predefined RSSI threshold. For example, FIG. 9 shows a variation in a UWB RSSI value according to distance according to an embodiment of the disclosure. In FIG. 9, the x coordinate denotes a distance (m, meter) and the y coordinate denotes an RSSI value (dBm, decibel milliwatt). The longer the distance, the smaller the RSSI value, and it may be interpreted that in a case where an RSSI value as a threshold is configured to be −70 dBm, if the distance is equal to or greater than 20 m, a RSSI value smaller than the threshold is generally obtained.

d(m) may denote the number of DL-TDoA messages received in the m-th round. For example, if m is equal to 3 and the number of DTMs received in a cluster corresponding to a third ranging round in a ranging block is 5 (e.g., one poll DTM, three response DTMs, and one final DTM are received), d (m) may be 5.

NARₘ may denote a set of active ranging rounds used in a neighboring cluster(s), based on information received from an m-th round message. For example, same may be represented as NARₘ={m|d(m)≥Dₜₕ,R̅S̅S̅I̅(m)≥RSSIₜₕ}. Here, Dₜₕ may indicate a threshold of the number (d) of messages.

CAR may denote a candidate active ranging round set derived based on received information. CAR may be determined as a sum of NARₘ that is an active ranging round set used in a neighboring cluster(s). For example, same may be represented as

$$CAR := {⋃}_{m = 0}^{M} {NAR}_{m} .$$

B may denote a ranging block duration.

K may indicate a predetermined number of ranging blocks to listen to.

TDOA_{m,n}(t) may denote an n-th TDoA value of the m-th round at time t.

TDOAₘ(t) may denote a set of TDoA values of the m-th round at time t. For example, same may be represented as TDOAₘ(t):={TDOA_{m,1}(t), TDOA_{m,2}(t), . . . , TDOA_{m,N}(t).

g_{m,n} may denote an n-th TDoA gap of the m-th round from time t to time t+kB. For example, same may be represented as g_{m,n}:=TDOA_{m,n}(t+kB)−TDOA_{m,n}(t). Here, the gap may indicate a magnitude difference of TDoA, and it may also be interpreted that the larger the gap, the lager the mobility.

Gₘ may indicate a set of gap values of the m-th round. For example, same may be represented as Gₘ:={g_{m,1}, g_{m,2}, . . . , g_{m,N}}.

g̅ indicates a mean gap for all rounds for which gap calculation is possible. For example, same may be represented as

$$\overline{g} := \frac{1}{\vert CAR \vert} {\sum }_{m ∈ CAR} \frac{1}{\vert {G}_{m} \vert} {\sum }_{{g}_{m , n} ∈ \vert {G}_{m} \vert} {g}_{m , n} .$$

velocity c of light may be used to consider c·g̅ as a mobility indicator (e.g., velocity) of a target device.

MAR may indicate a marginal set derived based on received information. MAR may be used to consider user mobility. For example, same may be represented as MAR={m|0≤d(m)<Dₜₕ,d(m)≤f(g̅)}.

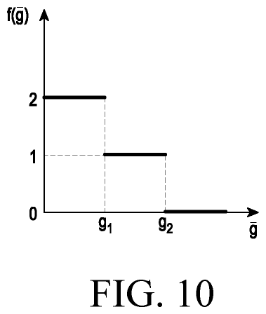

ƒ(g̅) may denote a step function value according to a mobility indicator. FIG. 10 shows a step function value according to g̅ according to an embodiment of the disclosure. The larger the g̅ value, the step function value ƒ(g̅) may become smaller. For example, if a gap is g1, the step function value is 2, and if a gap is g2, the step function value may be equal to 1.

HOST_AR may denote an active ranging round set determined by a host (or framework) of a higher application layer.

UWBS_AR may indicate an active ranging round set derived by a UWBS.

FINAL_AR may indicate an active ranging round set finally derived according to a selection mode.

A UWBS device may select, as FINAL_AR, one of HOST_AR, UWBS_AR, HOST_AR∩UWBS_AR, and HOST_AR∪UWBS_AR.

As a criterion for selecting FINAL_AR by the UWBS device, HOST_AR may be selected to reduce energy consumption, UWBS_AR may be selected to increase positioning accuracy and/or a success rate, HOST_AR∩UWBS_AR may be selected to minimize energy consumption, and HOST_AR∪UWBS_AR may be selected to maximize positioning accuracy and/or a success rate.

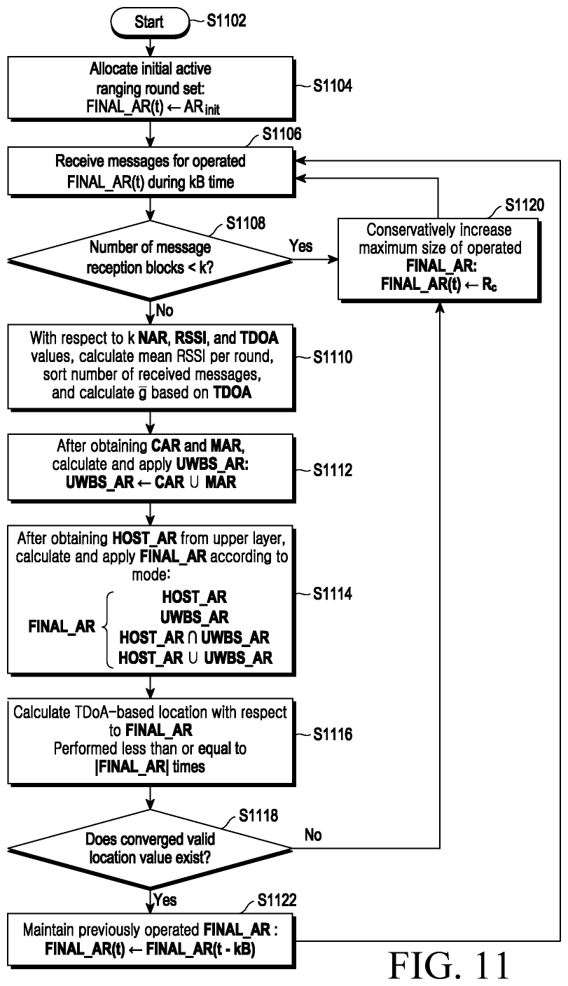

FIG. 11 is a flowchart illustrating a method of dynamically adjusting an active ranging round by a UWB device according to an embodiment of the disclosure.

An operation of the UWB device of FIG. 11 may correspond to an operation of a UWB framework or a UWBS of the UWB device. The operation of the UWB framework or the UWBS may be understood as an operation of a processor (e.g., application processor) including the UWB framework or a UWB device including the UWB framework.

In operation S1102, the UWB device (or terminal) may operate a UWB module. The UWB device may operate the UWB module to use a positioning service.

In operation S1104, the UWB device may allocate an initial active ranging round set. As the initial active ranging round set, FINAL_AR(t) may be used and is a previously used active ranging round set. According to an initial configuration, FINAL_AR(t) may be configured as ARᵢₙᵢₜ. In a case where there is no previous operation, the initial value may be configured to listening to all rounds.

In operation S1106, the UWB device may receive messages according to operated FINAL_AR(t) for a kB time by using a ranging block duration (B) and a predefined number (k) of ranging blocks to listen to.

In operation S1108, the UWB device may determine whether the number of blocks in which the messages are received in the operation S1106 is greater than or smaller than k.

If the number of blocks in which the messages are received is smaller than k in operation S1108, the UWB device may reconfigure the FINAL_AR value to have a maximum magnitude without using same without change in operation S1120. For example, R_{c} having all configurable ranging round values may be configured as FINAL_AR.

If the number of blocks in which the messages are received is equal to or greater than k in operation S1108, the UWB device may estimate k NAR, RSSI, and TDoA values from the received messages in operation S1110. NAR may be estimated through the number of received messages and an estimated RSSI. RSSI and TDoA may be estimated through a received DTM. The UWB device may use the estimated k NAR, RSSI, and TDoA values to determine a mean RSSI value per round, sort the number of received messages, and calculate g̅.

In operation S1112, the UWB device may obtain CAR and MAR by using the obtained values. CAR may represent a candidate active ranging round set determined by the UWB device, based on at least one of the estimated NAR and mean RSSI, TDoA, and g̅. MAR may be a marginal candidate active ranging round set determined by the UWB device, based on the number of received messages and the estimated g̅. UWBS_AR may be derived using the obtained CAR and MAR. For example, UWBS_AR may be represented as a union of the obtained CAR and MAR.

In operation S1114, the UWB device may obtain HOST_AR from an upper layer to obtain and determine FINAL_AR according to a policy configured for the terminal. According to an example, as a criterion for selecting FINAL_AR by the UWBS device, HOST_AR may be selected to reduce energy consumption, UWBS_AR may be selected to increase positioning accuracy and/or a success rate, HOST_AR∩UWBS_AR may be selected to minimize energy consumption, and HOST_AR∪UWBS_AR may be selected to maximize positioning accuracy and/or a success rate.

In operation S1116, the UWB device may calculate the TDoA-based location of the device, based on the determined FINAL_AR. When the location is calculated, the UWB device may perform calculation a FINAL_AR or smaller number of times to obtain the location.

In operation S1118, the UWB device may determine whether there is a valid location value into which location values obtained in operation S1116 converge.

If there is no converged valid location value in operation S1118, the UWB device may, in operation S1120, reconfigure FINAL_AR to have a maximum magnitude without using a value obtained in operation S1114. For example, R_{c} having all configurable ranging round values may be configured as FINAL_AR.

If there is a converged valid location value in operation S1118, the UWB device may maintain the determined FINAL_AR without change and use same for operation during a next time in operation S1122. For example, same may be applied to FINAL_AR(t) in operation S1106.

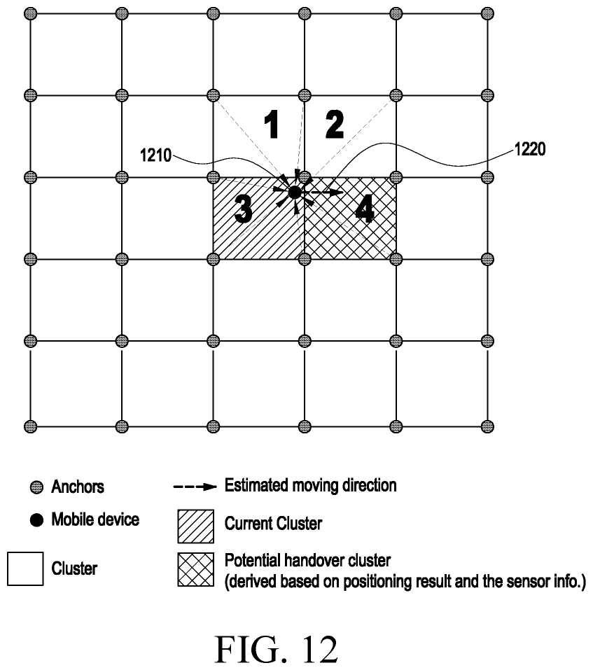

FIG. 12 shows an example in which a UWB device operates an active ranging round according to an embodiment of the disclosure.

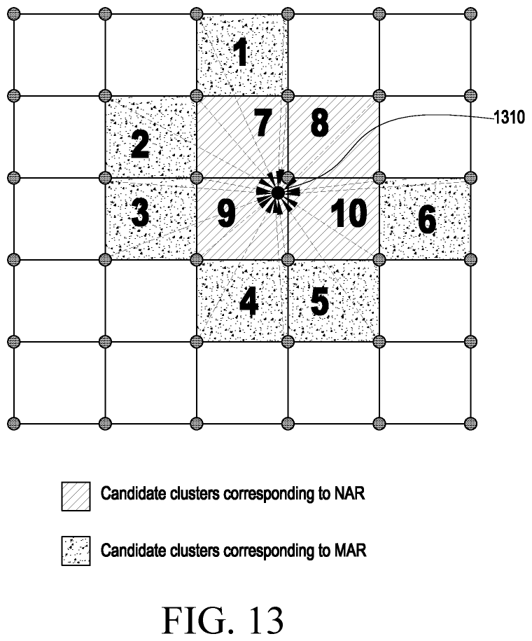

FIG. 13 shows another example in which a UWB device operates an active ranging round according to an embodiment of the disclosure.

In embodiments of FIG. 12 and FIG. 13, UWB anchors are assumed to be properly arranged in a particular area. In addition, the UWB anchors are assumed to transmit messages thereof in slots (scheduled slots) scheduled therefor. In addition, one cluster (cell) is assumed to have its unique round (ranging round). In addition, a master anchor of a cluster is assumed to include the length of a ranging block in a message of the master anchor. As an embodiment, at least one of anchors of a cluster disposed in the area may be configured as a master anchor. For example, an initiator anchor of the cluster may be configured as a master anchor. In the embodiments of FIG. 12 and FIG. 13, a UWB device of a user may be called a mobile or a mobile device.

The embodiment of FIG. 12 corresponds to an embodiment of estimating the location and movement direction (or movement) of the UWB device and operating an active ranging round, based on a result of the estimation.

The embodiment of FIG. 13 corresponds to an embodiment of estimating the location of the UWB device and operating an active ranging round according to a result of the estimation based on mobility.

FIG. 12 may show an example of a method in which a UWB device selects a ranging round for a particular cluster as an active ranging round, based on the current location and movement direction thereof according to HOST_AR information

In FIG. 12, a mobile device (or UWB device) may estimate the current location and movement direction of the UWB device, based on information for DL-TDoA localization received from anchors included in a cluster 3 where the device is currently positioned, and anchors included in neighboring clusters. For example, the UWB device may estimate a current location 1210 of the UWB device and a movement direction 1220 of the UWB device, based on location coordinates calculated based on ranging messages received from multiple UWB anchors.

The UWB device may derive, as a potential handover cluster, a cluster 4 to which the UWB device moving in the movement direction 1220 is getting closer, based on the estimated current location 1210 and movement direction 1220. The UWB device may determine the potential handover cluster 4 from a positioning result and information received from a sensor.

As an embodiment, in a cluster arrangement structure as illustrated in FIG. 12, in a case where the UWB device is estimated to be positioned at the current location 1210, the UWB device may determine a ranging round of at least one cluster adjacent to the current location 1210 as a candidate active ranging round. For example, the UWB device may determine ranging rounds of clusters #1, #2, and #4 adjacent to the current location 1210 as candidate active ranging rounds. In this case, when the UWB device determines HOST_AR as FINAL_AR according to a policy of the terminal, the UWB device may select, as an active ranging round, only a ranging round of the potential handover cluster 4 positioned in an area to which the UWB device is getting closer, based on the movement direction 1220.

In a case of the embodiment of FIG. 12, the estimation of a traveling direction obtained based on a sensor may incorrect. Therefore, the positioning accuracy and success rate of the terminal may be reduced. However, if the estimation of a traveling direction obtained based on a sensor is correct, all clusters corresponding to neighboring clusters are not determined as active ranging rounds, and only a potential handover cluster is determined as an active ranging round, so that energy may be saved maximally.

FIG. 13 may show an example of a method in which a UWB device selects a ranging round for a particular cluster as an active ranging round, based on the current location and movement direction thereof according to UWBS_AR information

In FIG. 13, a mobile device (or UWB device) may estimate the current location and movement direction of the UWB device, based on information for DL-TDoA localization received from anchors included in a cluster 9 where the device is currently positioned, and anchors included in neighboring clusters. For example, the UWB device may estimate a current location 1310 of the UWB device, based on location coordinates calculated based on ranging messages received from multiple UWB anchors.

The UWB device may determine neighboring clusters #7, #8, #9, and #10 as candidate active ranging rounds, based on the estimated current location 1310. A method of determining the nearest cluster, based on the current location 1310 may derive a candidate cluster determined based on NAR according to an embodiment of the disclosure.

In an embodiment, the UWB device may additionally determine, as a candidate active ranging round, a cluster adjacent to NAR as a neighboring cluster based on the estimated current location 1310. This method may derive a candidate cluster determined based on MAR according to an embodiment of the disclosure.

The UWB device may, when FINAL_AR is determined as FINAL_AR according to a policy of the terminal, determine, as active ranging rounds, all candidate active ranging rounds obtained by combining a candidate active ranging round determined by the NAR method and a candidate active ranging round determined by the MAR method.

In a case of the embodiment of FIG. 13, as many candidate clusters as possible are determined based on the current location 1310, and messages are received from all the candidate clusters to perform positioning, so that the accuracy and success rate of the positioning may be largely increased. However, the larger the number of candidate clusters, the larger the number of active ranging rounds and thus the energy consumption of the terminal may be increased.

The UWB device may determine FINAL_AR as HOST_AR, UWBS_AR, HOST_AR∩UWBS_AR, and HOST_AR∪UWBS_AR according to a policy or requirement of the terminal in an application layer or framework.

A DL-TDoA message according to an embodiment of the disclosure may include fields shown in Table 1 below in a payload field.

TABLE 1

| Parameters | Size (Bits) | Notes |
|---|---|---|
| Message | 24 | Configuration of the DTM as |
| Control | | defined in Table 2 |
| Round Index | 8 | Round index of the current ranging |
| | | round |
| Block Index | 16 | Block index of the current ranging |
| | | block |
| TX Timestamp | 40/48/64 | DTM transmission timestamp |
| | | represented as one of a local or a |
| | | common time base (in units of |
| | | 15.65 ps) |
| Responder | (0/24/32/40/ | N Responder DT-Anchor |
| DT-Anchor | 72/80/88)*N | Management List Elements |
| Management List | | |
| CFO | 0/16 | Clock frequency offset with respect |
| | | to Initiator DT-Anchor (in units of |
| | | ppm) |
| Reply Time List | (0/48/96)*M | M Reply Time List elements |
| Responder | 0/32 | Reply time of Responder |
| Reply Time | | DT-Anchor in it local time base |
| Responder ToF | 0/16 | ToF between an Initiator |
| Result | | DT-Anchor and a Responder |
| | | DT-Anchor measured by the |
| | | Responder DT-Anchor (in units of |
| | | 15.65 ps) as a result of DS-TWR |
| Inter-Cluster | 0/40 | Parameters used for multi-hop time |
| Synchronization | | synchronization in multi-cluster |
| | | scenarios |
| Anchor | 0/152 | The geo-location information of |
| Location | | DT-Anchor |
| Active Ranging | 0/variable | The information of ranging rounds |
| Round | | in which the DT-Anchor actively |
| Information | | operates, except for the current |
| | | ranging round in which this field is |
| | | transmitted |

Referring to Table 1, a DL-TDoA message may include at least one of a message control field, a round index field, a block index field, a transmission (TX) timestamp field, a responder DT-anchor management list field, a clock frequency offset (CFO) field, a reply time list field, a responder reply time field, a responder ToF result field, an inter-cluster synchronization field, an anchor location field, and an active ranging round information field.

The message control field may include configuration information of a DTM defined in Table 2 below. The active ranging round information field may include information on a ranging round in which a DT-anchor actively operates except for the current ranging round in which the field is transmitted. The active ranging round information field will be described in detail with reference to Table 3.

TABLE 2

| Parameters | Size (Bits) | Notes |
|---|---|---|
| Responder DT-Anchor | 4 | Number of elements in Responder DT-Anchor |
| Management List Length | | Management List |
| Ranging Slot Index | 1 | Presence of Ranging Slot Index field in Responder |
| Present | | DT-Anchor Management List |
| | | 0: Ranging Slot Index field is not present, |
| | | 1: Ranging Slot Index field is present |
| ToF Result Present | 1 | Presence of ToF Result field in Responder |
| | | DT-Anchor Management List |
| | | 0: ToF Result field is not present, |
| | | 1: ToF Result field is present |
| Reply Time List Length | 4 | Number of elements in the Reply Time List field |
| Final DTM Present | 1 | Whether Final DTM is transmitted or not |
| | | 0: Final DTM is not transmitted, |
| | | 1: Final DTM is transmitted |
| TX Timestamp Length | 2 | 0: the size of TX Timestamp field is 40 bit, |
| | | 1: the size of TX Timestamp field is 48 bit |
| | | 2: the size of TX Timestamp field is 64 bit, |
| | | 3: RFU |
| TX Timestamp Type | 1 | Type of time base for TX Timestamp 0: local time |
| | | base (used for other purpose than calculating TDoA) |
| | | 1: common time base (enough to be used to calculate |
| | | TDoA) |
| CFO Present | 1 | Presence of CFO field |
| | | 0: CFO not present, |
| | | 1: CFO is present |
| Responder ToF Result | 1 | Presence of Responder ToF Result field |
| Present | | 0: Responder ToF Result field is not present, |
| | | 1: Responder ToF Result field is present |
| Inter-Cluster | 1 | Presence of Inter-Cluster Synchronization field |
| Synchronization | | 0: Inter-Cluster Synchronization field is not present, |
| Present | | 1: Inter-Cluster Synchronization field is present |
| Anchor Location | 1 | Presence of Anchor Location field |
| Present | | 0: Anchor Location field is not present, |
| | | 1: Anchor Location field is present |
| Active Ranging Round | 1 | Presence of Active Ranging Round information field |
| Information Present | | 0: Active Ranging Round Information is not present, |
| | | 1: Active Ranging Round Information is present |
| Reserved | 5 | Reserved for future use |

Table 2 may show fields included in the message control field in Table 1. The message control field may include at least one of a responder DT-anchor management list length field, a ranging slot index present field, a ToF result present field, a reply time list length field, a final DTM present field, a TX timestamp length field, a TX timestamp type field, a CFO present field, a responder ToF result present field, an inter-cluster synchronization present field, an anchor location present field, and an active ranging round information present field.

If the active ranging round information present field has a value of 0, this indicates that there is no active ranging round information, and if the field has a value of 1, this may indicate that there is active ranging round information.

TABLE 3

| | Size | |
|---|---|---|
| Parameters | (Bits) | Notes |
| Active | 8 | Number of elements of the following Active |
| Ranging | | Ranging Round List field. |
| Round List | | This value represents the number of clusters in |
| Length | | which the DT-Anchor, transmitting this field, |
| | | operates, except for the current ranging round. |
| Active | 8*L | a list of Round Index values of the ranging rounds |
| Ranging | | in which the DT-Anchor, transmitting this field, |
| Round List | | operates. The Round Index of the current ranging |
| | | round in which this field is transmitted is not |
| | | included in this list. |
| | | This field may be used by the DT-Tag to update |
| | | the list of active ranging rounds by recognizing the |
| | | Round Index values of the ranging rounds used by |
| | | the adjacent clusters. |

Table 3 shows fields included in the active ranging round information field of Table 1. The active ranging round information field may include at least one field among an active ranging round list length field and an active ranging round list field.

The active ranging round list length field may indicate the number of clusters in which a DT-anchor transmitting a message operates, excluding the current ranging round. The active ranging round list field may indicate a list of round index values of ranging rounds in which a DT-anchor transmitting a message operates. The round index of the current ranging round in which the active ranging round list field is transmitted may not be included in the active ranging round list field. The active ranging round list field may be used by a DT-tag to update a list of active ranging rounds by recognizing the round index value of a ranging round used by a neighboring cluster.

A UWB device, according to an embodiment of the disclosure, having received a DL-TDoA message may report a DL-TDoA ranging measurement result including the content in Table 4 below.

TABLE 4

| Parameters | Size (Bits) | | Notes |
|---|---|---|---|
| MAC Address | 2/8 | Octets | |
| Status | 1 | Octet | |
| Message Type | 1 | Octet | |
| Message Control | 2 | Octets | |
| Block Index | 2 | Octets | |
| Round Index | 1 | Octet | |
| NLoS | 1 | Octet | |
| AoA Azimuth | 2 | Octets | |
| AoA Azimuth FOM | 1 | Octet | |
| AoA Elevation | 2 | Octets | |
| AoA Elevation FOM | 1 | Octet | |
| TX Timestamp | 5/6/8 | Octets | |
| RX Timestamp | 8 | Octets | |
| CFO_ANCHOR | 2 | Octets | |
| CFO | 2 | Octets | |
| Initiator Reply Time | 4 | Octets | |
| Responder Reply Time | 4 | Octets | |
| Initiator - Responder ToF | 2 | Octets | |
| Anchor Location | 0/20 | Octets | |
| Active Ranging Rounds | L | Octets | List of L active ranging round indexes in |
| | | | which the DT-Anchor associated to this |
| | | | measurement result is present. The |
| | | | number of L active ranging rounds is |
| | | | indicated in the Message Control field of |
| | | | the measurement result. |
| RSSI | 2 | Octets | Received signal strength indicator in dBm |

Referring to Table 4, a DL-TDoA ranging measurement result message may include at least one field among a MAC address field, a status field, a message type field, a message control field, a block index field, a round index field, an non line-of-sight (NLoS) field, an angle-of-arrival (AoA) azimuth field, an AoA azimuth FOM field, an AoA elevation field, an AoA elevation FOM field, a transmission (TX) timestamp field, a reception (RX) timestamp field, a CFO_ANCHOR field, a CFO field, an initiator reply time field, a responder reply time field, an initiator-responder ToF field, an anchor location field, an active ranging round field, and a received signal strength indicator (RSSI) field.

The active ranging round field may include a list of active ranging round indexes having an L size, in which an anchor related to a DL-TDoA ranging measurement result exists. The number of active ranging rounds, which has an L size, may be indicated in the message control field of the measurement result.

Table 5 and Table 6 represent a COMMAND message transmitted from an upper layer to a lower layer after an active ranging round set is determined, and a RESPONSE message transmitted to the upper layer from the lower layer having received the COMMAND message.

TABLE 5
SESSION_UPDATE_ACTIVE_ROUNDS_DT_TAG_CMD

| Payload | | |
|---|---|---|
| Field(s) | Length | Value/Description |
| Session ID | 4 | Session ID of the DL-TDoA session whose |
| | Octets | active ranging rounds need to be activated. |
| Number of | 1 | Number of ranging rounds in which a UWBS is |
| ranging | Octets | active as DT-Tag. Values can be 1 <= |
| round | | N <= DT_TAG_MAX_ACTIVE_RR |
| Ranging Round | N | List of the N active ranging round indexes |
| Indexes | Octets | where the UWBS shall listen for DL-TDoA |
| | | messages from DT-Anchors. |

Referring to Table 5, an upper layer node may transmit a session update active ranging round command message (SESSION_UPDATE_ACTIVE_ROUNDS_DT_TAG_CMD). The session update active ranging round command message may include at least one field among a session identifier (ID) field, a number-of-ranging rounds field, and a ranging round index field.

The session identifier field may indicate a session ID of a DL-TDoA session in which an active ranging round needs to be activated. The number-of-ranging rounds field may indicate the number of ranging rounds in which a UWBS is activated as a DT-tag. The ranging round index field may indicate a list of N active ranging round indexes where the UWBS are to receive DL-TDoA messages from DT-Anchors.

TABLE 6
SESSION_UPDATE_ACTIVE_ROUNDS_DT_TAG_RSP

| Payload | | |
|---|---|---|
| Field(s) | Length | Value/Description |
| Status | 1 | STATUS_OK for success |
| | Octets | |
| Number of | 1 | Number of ranging rounds (N) that could not be |
| ranging | Octets | activated. This value should be set to 0x00 if |
| round | | the Status field of the response is STATUS_OK. |
| | | Values can be 0 <= N <= 255 |
| Ranging | N | List of the N ranging round indexes that |
| Round | Octets | could not be activated. |
| Indexes | | |

Referring to Table 6, a lower layer node may, when a session update active ranging round command message (SESSION_UPDATE_ACTIVE_ROUNDS_DT_TAG_CMD) is received from an upper layer, apply a corresponding command and then transmit a response message (SESSION_UPDATE_ACTIVE_ROUNDS_DT_TAG_RSP) to the upper layer through a UCI.

The response message may include at least one field among a status field, a number-of-ranging rounds field, and a ranging round index field.

The status field may indicate “STATUS_OK” for success. The number-of-ranging rounds field may indicate the number of non-activable ranging rounds. The number-of-ranging rounds field may have a value of 0 when the status field is “STATUS_OK”. The ranging round index field may indicate a list of N non-activable ranging round indexes.

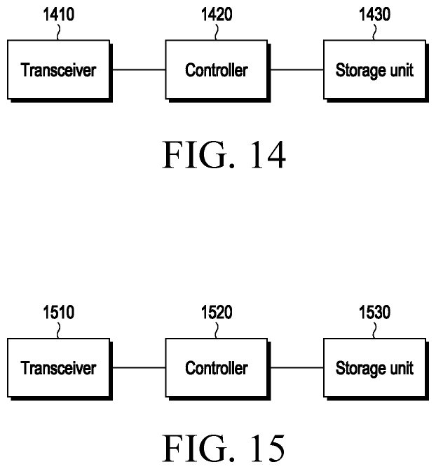

FIG. 14 illustrates a structure of a UWB device according to an embodiment of the disclosure.

In an embodiment of FIG. 14, the UWB device may be correspond to the UWB device in FIG. 1 or include the UWB device, or an electronic device including a part of the UWB device.

In an embodiment of FIG. 14, the UWB device may be a UWB device functioning as a tag (DT-tag) for DL-TDoA.

Referring to FIG. 14, the UWB device may include a transceiver 1410, a controller 1420, and a storage unit 1430. The controller in the disclosure may be defined as a circuit, an application-specific integrated circuit, or at least one processor. The UWB device may be configured to include all the transceiver 1410, the controller 1420, and the storage unit 1430, or at least one element thereamong.

The transceiver 1410 may transmit or receive a signal to or from another entity. Th transceiver 1410 may transmit or receive data to or from another device by using, for example, UWB communication or OOB communication (e.g., BLE communication).

The controller 1420 may control the overall operation of an electronic device according to an embodiment proposed in the disclosure. For example, the controller 1420 may control a signal flow between blocks to perform operations according to the flowcharts illustrated above. Specifically, the controller 1420 may control, for example, an operation of a UWB device (e.g., an operation of an application layer, or a framework or UWBS of the UWB device) described with reference to FIG. 1 to FIG. 13. For example, the controller 1420 may receive ranging messages transmitted by a UWB anchor to perform a DL-TDoA operation.

The storage unit 1430 may store at least one of information transmitted or received through the transceiver 1410 and information generated through the controller 1420. For example, the storage unit 1430 may store, for example, information and data (e.g., active ranging round information) required for a method described with reference to FIG. 1 to FIG. 13.

FIG. 15 illustrates a structure of a UWB device according to an embodiment of the disclosure.

In an embodiment of FIG. 15, the UWB device may be correspond to the UWB device in FIG. 1 or include the UWB device, or an electronic device including a part of the UWB device.

In an embodiment of FIG. 15, the UWB device may be a UWB device (DT-anchor) functioning as an anchor for DL-TDoA. For example, a UWB anchor may be an initiator anchor or a responder anchor.

Referring to FIG. 15, the UWB device may include a transceiver 1510, a controller 1520, and a storage unit 1530. The controller in the disclosure may be defined as a circuit, an application-specific integrated circuit, or at least one processor. According to an embodiment, the UWB device may be configured to include all the transceiver 1510, the controller 1520, and the storage unit 1530, or at least one element thereamong.

The transceiver 1510 may transmit or receive a signal to or from another entity. The transceiver 1510 may transmit or receive data to or from another device by using, for example, UWB communication.

The controller 1520 may control the overall operation of an electronic device according to an embodiment proposed in the disclosure. For example, the controller 1520 may control a signal flow between blocks to perform operations according to the flowcharts illustrated above. Specifically, the controller 1520 may control, for example, an operation (e.g., an operation of transmitting a ranging message) of a UWB anchor described with reference to FIG. 1 to FIG. 13. For example, the controller 1520 UWB anchor may transmit ranging messages for DL-TDoA.

The storage unit 1530 may store at least one of information transmitted or received through the transceiver 1510 and information generated through the controller 1520. For example, the storage unit 1530 may store, for example, information and data (e.g., response time information and anchor location information) required for a method described with reference to FIG. 1 to FIG. 13.

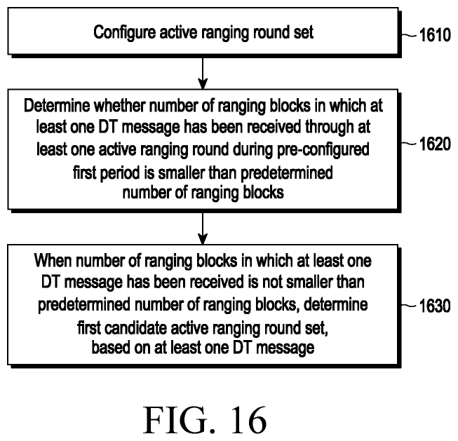

FIG. 16 is a flowchart illustrating a method of a UWB device according to an embodiment of the disclosure.

In an embodiment of FIG. 16, the UWB device may be correspond to the UWB device in FIG. 1 or include the UWB device, or an electronic device including a part of the UWB device.

In an embodiment of FIG. 16, the UWB device may be a UWB device functioning as a tag for DL-TDoA. The UWB device may include a transceiver and at least one processor.

A first method according to the embodiment of FIG. 16 may be performed by an upper layer (e.g., a UWB framework, an application layer, or a processor (application processor) including a UWB framework and an application) or a UWBS of the UWB device. The method of FIG. 16 may refer to the description of the methods of FIG. 8 to FIG. 13.

Referring to FIG. 16, the UWB device may configure an active ranging round set (operation 1610). The active ranging round set may include at least one active ranging round in which the UWB device operates as a DT tag that receives a DT message from a DL-TDoA (DT) anchor.

The UWB device may determine whether the number of ranging blocks in which at least one DT message has been received through the at least one active ranging round during a preconfigured first period is smaller than a predetermined number of ranging blocks (operation 1620).

The UWB device may, when the number of ranging blocks in which the at least one DT message has been received is not smaller than the predetermined number of ranging blocks, determine a first candidate active ranging round set, based on the at least one DT message (operation 1630).

As an embodiment, the UWB device may obtain a second candidate active ranging round set from an application.

As an embodiment, the UWB device may reconfigure one of the first candidate active ranging round set and the second candidate active ranging round set as the active ranging round set.

As an embodiment, the UWB device may perform a DL-TDoA operation, based on the reconfigured active ranging round set.

As an embodiment, the UWB device may determine whether location information of the UWB device obtained by performing the DL-TDoA operation is valid.

As an embodiment, the UWB device may, when the location information is not valid, reconfigure the active ranging round set to be a ranging round set in which all configurable ranging rounds are configured as active ranging rounds, and when the location information is valid, maintain the active ranging round set.

As an embodiment, the UWB device may, when the number of ranging blocks in which the at least one DT message has been received is smaller than the predetermined number of ranging blocks, reconfigure the active ranging round set to be a ranging round set including all configurable ranging rounds.

As an embodiment, the UWB device may obtain a second candidate active ranging round set from an application, determine, as a third candidate active ranging round set, an active ranging round included in both the first candidate active ranging round set and the second candidate active ranging round set, determine, as a fourth candidate active ranging round set, a set obtained by combining an active ranging round included in the first candidate active ranging round set and an active ranging round included in the second candidate active ranging round set, and reconfigure, as the active ranging round set, one of the first candidate active ranging round set, the second candidate active ranging round set, the third candidate active ranging round set, and the fourth candidate active ranging round set.

As an embodiment, the DT-TDoA message may include at least one field among a message control field and an active ranging round information field, the message control field may include a field indicating whether the active ranging round information field exists, and the active ranging round information field may include at least one of a first field indicating the number of at least one cluster in which a UWB device having transmitted the DT message operates except for a current ranging round, and a second field indicating a list of a round index value of at least one ranging round in which a UWB device having transmitted the DT message operates except for the current ranging round.

As an embodiment, the first candidate active ranging round set may be determined based on information on an active ranging round set used by a neighboring cluster, a received signal strength indicator (RSSI), and a TDoA value, and the information on the active ranging round set used by the neighboring cluster may be determined based on the number of the at least one DT message and the RSSI.

The above-described specific embodiments may be controlled to be performed by at least one processor included in the UWB device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of an ultra-wideband (UWB) device in a wireless communication system, the method comprising:
configuring an active ranging round set, the active ranging round set including at least one active ranging round in which the UWB device operates as a DT tag that receives a DT message from a DL-TDoA (DT) anchor;
determining whether a number of ranging blocks in which at least one DT message has been received through the at least one active ranging round during a preconfigured first period is smaller than a predetermined number of ranging blocks; and
in case that the number of ranging blocks in which the at least one DT message has been received is not smaller than the predetermined number of ranging blocks, determining a first candidate active ranging round set, based on the at least one DT message.

2. The method of claim 1, further comprising:
obtaining a second candidate active ranging round set from an application; and
reconfiguring one of the first candidate active ranging round set and the second candidate active ranging round set as the active ranging round set.

3. The method of claim 2, further comprising performing a DL-TDoA operation, based on the reconfigured active ranging round set.

4. The method of claim 3, further comprising:
determining whether location information of the UWB device, obtained by performing the DL-TDoA operation, is valid;
in case that the location information is not valid, reconfiguring the active ranging round set to a ranging round set in which all configurable ranging rounds are configured as active ranging rounds; and
in case that the location information is valid, maintaining the active ranging round set.

5. The method of claim 1, further comprising, in case that the number of ranging blocks in which the at least one DT message has been received is smaller than the predetermined number of ranging blocks, reconfiguring the active ranging round set to a ranging round set including all configurable ranging rounds.

6. The method of claim 1, further comprising:
obtaining a second candidate active ranging round set from an application; and
determining, as a third candidate active ranging round set, an active ranging round included in both the first candidate active ranging round set and the second candidate active ranging round set;
determining, as a fourth candidate active ranging round set, an active ranging round included in the first candidate active ranging round set and an active ranging round included in the second candidate active ranging round set in combination; and
reconfiguring, as the active ranging round set, one of the first candidate active ranging round set, the second candidate active ranging round set, the third candidate active ranging round set, and the fourth candidate active ranging round set.

7. The method of claim 1, wherein the DT message comprises at least one field among a message control field and an active ranging round information field,
wherein the message control field comprises a field indicating whether the active ranging round information field exists, and
wherein the active ranging round information field comprises at least one of a first field indicating a number of at least one cluster in which a UWB device having transmitted the DT message operates, except for a current ranging round, and a second field indicating a list of round index values of at least one ranging round in which the UWB device having transmitted the DT message operates except for the current ranging round.

8. The method of claim 1, wherein the first candidate active ranging round set is determined based on information on an active ranging round set used by a neighboring cluster, a received signal strength indicator (RSSI), and a TDoA value, and
wherein information on the active ranging round set used by the neighboring cluster is determined based on a number of the at least one DT message and the RSSI.

9. A UWB device in a wireless communication system, the UWB device comprising:
a transceiver; and
at least one processor connected to the transceiver,
wherein the at least one processor is configured to:
configure an active ranging round set, the active ranging round set including at least one active ranging round in which the UWB device operates as a DT tag that receives a DT message from a DL-TDoA (DT) anchor;
determine whether a number of ranging blocks in which at least one DT message has been received through the at least one active ranging round during a preconfigured first period is smaller than a predetermined number of ranging blocks; and
in case that the number of ranging blocks in which the at least one DT message has been received is not smaller than the predetermined number of ranging blocks, determine a first candidate active ranging round set, based on the at least one DT message.

10. The UWB device of claim 9, wherein the at least one processor is further configured to:
obtain a second candidate active ranging round set from an application;
reconfigure one of the first candidate active ranging round set and the second candidate active ranging round set as the active ranging round set; and
perform a DL-TDoA operation, based on the reconfigured active ranging round set.

11. The UWB device of claim 10, wherein the at least one processor is further configured to:
determine whether location information of the UWB device obtained by performing the DL-TDoA operation is valid;
in case that the location information is not valid, reconfigure the active ranging round set to a ranging round set in which all configurable ranging rounds are configured as active ranging rounds; and
in case that the location information is valid, maintain the active ranging round set.

12. The UWB device of claim 9, wherein the at least one processor is further configured to, in case that the number of ranging blocks in which the at least one DT message has been received is smaller than the predetermined number of ranging blocks, reconfigure the active ranging round set to a ranging round set including all configurable ranging rounds.

13. The UWB device of claim 9, wherein the at least one processor is further configured to:
obtain a second candidate active ranging round set from an application;
determine, as a third candidate active ranging round set, an active ranging round included in both the first candidate active ranging round set and the second candidate active ranging round set;
determine, as a fourth candidate active ranging round set, an active ranging round included in the first candidate active ranging round set and an active ranging round included in the second candidate active ranging round set in combination; and
reconfigure, as the active ranging round set, one of the first candidate active ranging round set, the second candidate active ranging round set, the third candidate active ranging round set, and the fourth candidate active ranging round set.

14. The UWB device of claim 9, wherein the DT message comprises at least one field among a message control field and an active ranging round information field,
wherein the message control field comprises a field indicating whether the active ranging round information field exists, and
wherein the active ranging round information field comprises at least one of a first field indicating a number of at least one cluster in which a UWB device having transmitted the DT message operates except for a current ranging round, and a second field indicating a list of a round index value of at least one ranging round in which a UWB device having transmitted the DT message operates except for the current ranging round.

15. The UWB device of claim 9, wherein the first candidate active ranging round set is determined based on information on an active ranging round set used by a neighboring cluster, a received signal strength indicator (RSSI), and a TDoA value, and
wherein information on the active ranging round set used by the neighboring cluster is determined based on a number of the at least one DT message and the RSSI.
